(19) United States
(12) Patent Application Publication
(10) Pub. No.: US 2009/0314150 A1
(43) Pub. Date: Dec. 24, 2009

(54) DIE FOR COOPERATING WITH A PUNCH

(75) Inventor: Chun-Hsin Tsai, Gueiren Township (TW)

Correspondence Address: CHOATE, HALL & STEWART LLP, TWO INTERNATIONAL PLACE, BOSTON, MA, 02110, US

(73) Assignee: SAN SHING FASTECH CORP., Kuei Jen Hsiang (TW)

(21) Appl. No.: 12/145,287

(22) Filed: Jun. 24, 2008

(51) Int. Cl. B26F 1/14

(52) U.S. Cl. 83/686

(57) ABSTRACT

A die cooperates with a punch to pierce a blank, and includes a hollow die body and at least one limiting unit. The die body has a top surface adapted to support the blank, a bottom surface, and a through hole extending through the top and bottom surfaces. The through hole is adapted to permit a scrap from the blank to move therethrough. The limiting unit has a limit component which is disposed in the die body below the top surface. The limit component is resiliently movable between a non-limit position where the scrap is permitted to pass through the limit component when being pushed downward by the punch, and a limit position, where the scrap is limited from moving upward when the punch is pulled upward.

### BACKGROUND OF THE INVENTION

1. Field of the Invention

The invention relates to a die, more particularly to a die for cooperating with a punch to pierce a blank, such as a nut blank.

2. Description of the Related Art

Referring to FIG. 1, when manufacturing a nut, a nut blank 11 has to be punched for the subsequent tapping process. Before being punched, the nut blank 11 is placed fixedly on a top surface of an annular conventional die 12. The conventional die 12 has an annular base portion 121 on which the nut blank 11 is placed, and a pair of radially opposite limit protrusions 122 protruding radially and inwardly from an annular inner surface of the annular base portion 121. When punching the nut blank 11, a punch 13 moves downwardly to pierce the nut blank 11, thereby resulting in a scrap 111 that will be squeezed into a space between the limit protrusions 122. Therefore, the scrap 111 can be limited from moving upwardly when the punch 13 moves upwardly back to its normal position.

However, frequent actions of squeezing the scraps 111 through the limit protrusions 122 of the conventional die 12 usually wear the limit protrusions 122, and hence enlarge the space between the limit protrusions 122. Consequently, the limit protrusions 122 will eventually be unable to clamp tightly the scrap 111 therebetween during the punching process, and the conventional die 12 needs to be replaced with a new one. The replacement of the conventional die 12 results in inconvenience during the nut manufacturing process, and also incurs higher manufacturing costs.

### SUMMARY OF THE INVENTION

Therefore, an object of the present invention is to provide a die that is durable and that is convenient for use in punching a nut blank.

According to some aspects of the present invention a die is to cooperate with a punch to pierce a blank and comprises a hollow die body and at least one limiting unit. The die body has a top surface adapted to support the blank, a bottom surface, and a through hole extending through the top and bottom surfaces. The through hole is adapted to permit a scrap from the blank to move therethrough. The limiting unit has a limit component which is disposed in the die body below the top surface. The limit component is resiliently movable between a non-limit position where the scrap is permitted to pass through the limit component when being pushed downward by the punch, and a limit position, where the scrap is limited from moving upward when the punch is pulled upward.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional die;

FIG. 2 is an exploded perspective partly cutaway view of a first embodiment of a die according to the invention;

FIG. 3 is a sectional view of the first embodiment, illustrating a limit component at a limit position;

FIG. 4 is another sectional view of the first embodiment, illustrating the limit component at a non-limit position;

FIG. 5 is a sectional view of a second embodiment of the die according to the invention;

FIG. 6 is a sectional view of a third embodiment of the die according to the invention;

FIG. 7 is an exploded perspective partly cutaway view of a fourth embodiment of the die according to the invention;

FIG. 8 is a sectional view of the fourth embodiment;

FIG. 9 is a sectional view of a fifth embodiment of the die according to the invention; and

FIG. 10 is a fragmentary enlarged sectional view of the fifth embodiment.

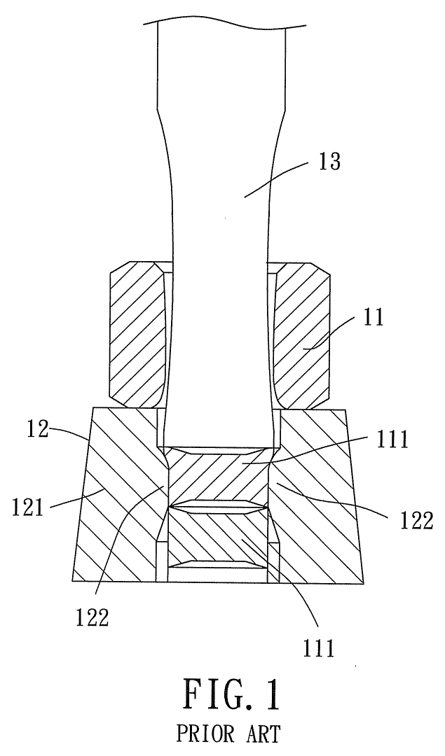

### DETAILED DESCRIPTION

Before the present invention is described in greater detail, it should be noted that like elements are denoted by the same reference numerals throughout the disclosure.

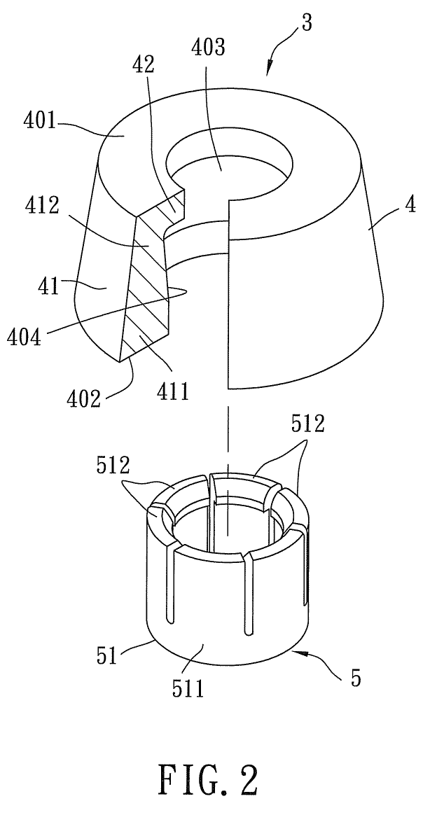

As shown in FIGS. 2 to 4, the first embodiment of a die 3 according to the present invention cooperates with a punch 200 to pierce a nut blank 100. When the nut blank 100 is pierced, a scrap 101 (see FIG. 4) from the nut blank 100 will be generated. The scrap 101 has a bottom end formed with an annular inclined push surface 102 that inclines upwardly and outwardly. In this embodiment, the die 3 comprises a hollow die body 4 and a limiting unit 5.

The die body 4 includes an annular base portion 41 and an annular flange portion 42. The annular base portion 41 has a top surface 401 adapted to support the nut blank 100 thereon, a bottom surface 402, and a through hole 403 extending through the top and bottom surfaces 401, 402 and adapted to permit the scrap 101 from the nut blank 100 to move therethrough. The annular flange portion 42 protrudes radially and inwardly from the base portion 41 near the top surface 401.

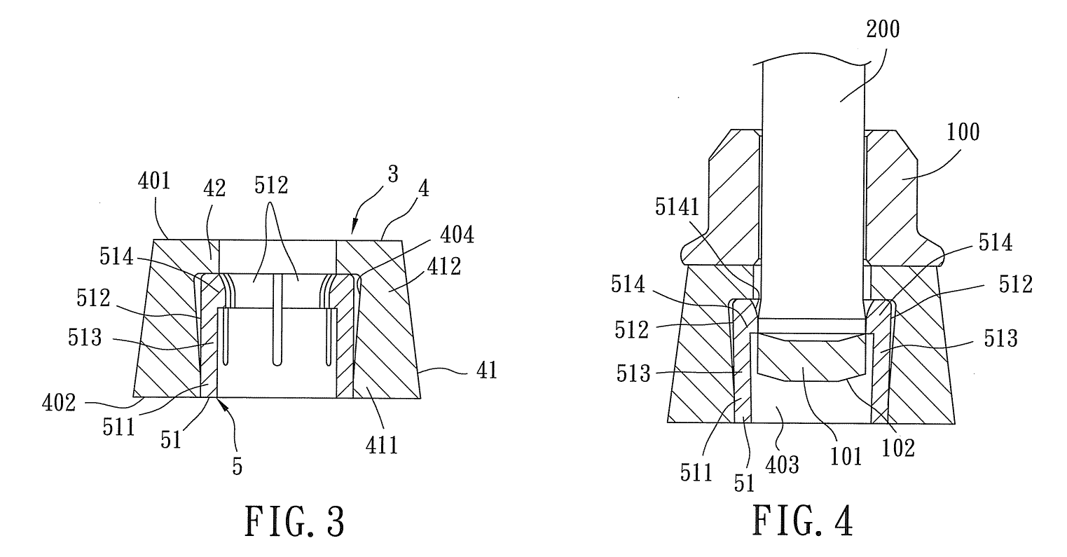

The limiting unit 5 has a limit component 51 disposed in the annular base portion 41 of the die body 4 below the top surface 401. The limit component 51 is resiliently movable between a non-limit position (see FIG. 4), where the scrap 101 is permitted to pass through the limit component 51 when being pushed downward by the punch 200, and a limit position (see FIG. 3), where the scrap 101 is limited from moving upward when the punch 200 is pulled upward. The limit component 51 has an annular stationary portion 511 disposed fittingly within the through hole 403 in the annular base portion 41 of the die body 4 below the annular flange portion 42 of the die body 4, and a plurality of angularly spaced apart resilient plates 512. In this embodiment, the resilient plates 512 project axially and upwardly from the annular stationary position 511 to a bottom end of the annular flange portion 42 of the die body 4, and are bendable outward in directions away from the center of the through hole 403 in the arinular base portion 41 of the die body 4 so as to expand to the non-limit position. Each of the resilient plates 512 of the limit component 51 has a resilient arm section 513 projecting upwardly and bendably from the annular stationary portion 511 of the limit component 51, and a flanged end 514 protruding radially and inwardly from a top end of the resilient arm section 513 opposite to the annular stationary portion 511. The resilient arm sections 513 define an inner diameter larger than the diameter of the scrap 101 and the punch 200. The flanged ends 514 have an inner surface 5141 that converges downwardly, such that a bottom end of the inner surface 5141 defines an inner diameter smaller than the diameter of the scrap 101 and the punch 200.

The annular base portion 41 of the die body 4 further has an abutment section 411 proximate to the bottom surface 402 to abut against and retain the annular stationary portion 511 of the limit component 51 of the limiting unit 5, a resilient plate-receiving section 412 formed between the abutment section 411 and the annular flange portion 42 of the die body 4, and an annular internal surface 404 converging downwardly from a bottom end of the annular flange portion 42 of the die body 4 to the bottom surface 402.

Referring to FIG. 4, when the punch 200 pierces the nut blank 100, the scrap 101 from the nut blank 100 is pushed downwardly by the punch 200 to pass through the annular flange portion 42 of the die body 4. At this time, the inclined push surface 102 of the scrap 101 pushes the inner surfaces 5141 of the flanged ends 514 of the resilient plates 512, so that the resilient plates 512 are pushed away in directions away from the center of the through hole 403 in the annular base portion 41 of the die body 4 and that the limit component 51 of the limiting unit 5 is placed in the non-limit position. When the punch 200 reaches the flanged ends 514 of the resilient plates 512, the scrap 101 passes through the flanged ends 514. When the punch 200 is pulled upward and away from the limit component 51, the limit component 51 moves immediately and resiliently from the non-limit position to the limit position so that the scrap 101 is limited by the flanged ends 514 of the resilient plates 512 from moving upward.

Compared to the prior art, the limit component 51 of the limiting unit 5 is resiliently movable between the non-limit and limit positions without being damaged during the punching process, thereby resulting in a more longer service life. It should be noted that, In this embodiment, while the flanged ends 514 of the resilient plates 512 are designed with inner surfaces 5141 that converge downwardly so as to correspond to the inclined push surface 102 of the scrap 101, the outline of the flanged ends 514 should not be limited thereto. The flanged ends 514 may have other outlines in other embodiments as long as the resilient plates 512 can be bent by the punch 200 and the scrap 101 to expand the limit component 51 to the non-limit position.

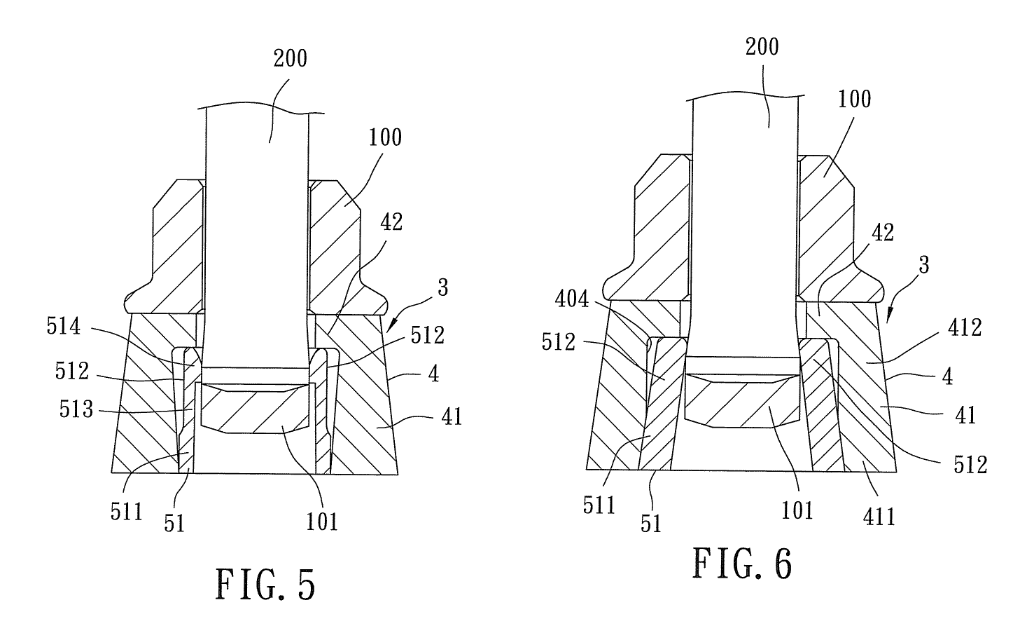

As shown in FIG. 5, the second embodiment of the die 3 according to the present invention has a structure similar to that of the first embodiment. The main difference between this embodiment and the previous embodiment resides in the outline of the resilient plates 512 of the limit component 51. In particular, the resilient arm sections 513 of the resilient plates 512 have a thickness which is smaller than that of the annular stationary portion 511 of the limit component 51 so that the resilient plates 512 have outer surfaces which are indented relative to an outer surface of the annular stationary portion 511. The second embodiment has the same advantages as those of the first embodiment.

As shown in FIG. 6, the third embodiment of the die 3 according to the present invention has a structure similar to the first embodiment. The main difference between this embodiment and the first embodiment resides in the following. The annular internal surface 404 of the annular base portion 41 of the die body 4 converges upwardly from the bottom surface 402 in the abutment section 411 and has a constant cross-section in the resilient plate-receiving section 412. The annular stationary portion 511 of the limit component 51 abuts against the abutment section 411 of the annular base portion 41 and converges upwardly from the bottom surface 402 of the annular base portion 41. The resilient plates 512 of the limit component 51 extend upwardly and convergingly from the annular stationary portion 511 into the resilient plate-receiving section 412. The third embodiment has the same advantages as those of the first embodiment.

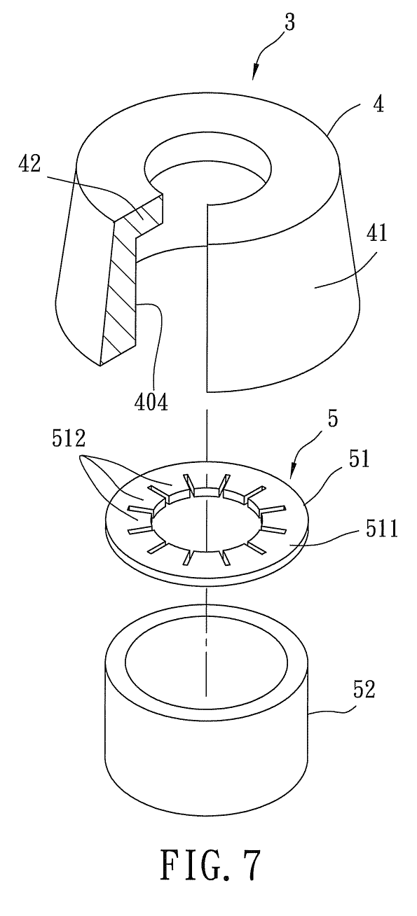

Referring to FIGS. 7 and 8, the fourth embodiment of the die 3 according to the present invention has a structure similar to the first embodiment. The main difference between this embodiment and the first embodiment resides in the following. The annular internal surface 404 of the annular base portion 41 of the die body 4 has a constant cross section. The limit component 51 of the limiting unit 5 has an annular stationary portion 511 fixed within the through hole 403 in the annular base portion 41 of the die body 4 below the annular flange portion 42, and a plurality of radially and inwardly projecting resilient plates 512 that are spaced apart annularly and that are resiliently bendable downward to move away from the center of the through hole 403 when being pushed by the punch 200. The inner ends of the resilient plates 512 define an inner diameter smaller than the width of the scrap 101 and the punch 200. The limiting unit 5 further has an annular positioning component 52 fixed within the through hole 403 below the annular stationary portion 511, such that the annular stationary portion 511 is clamped by the annular positioning component 52 and the annular flange portion 42. It should be noted that the annular positioning component 52 is optional, and the limit component 51 may be secured directly to the bottom end of the annular flange portion 42. Therefore, in practice, the securing of the limit component 51 should not be limited to the embodiments as described above. The fourth embodiment has the same advantages as those of the first embodiment.

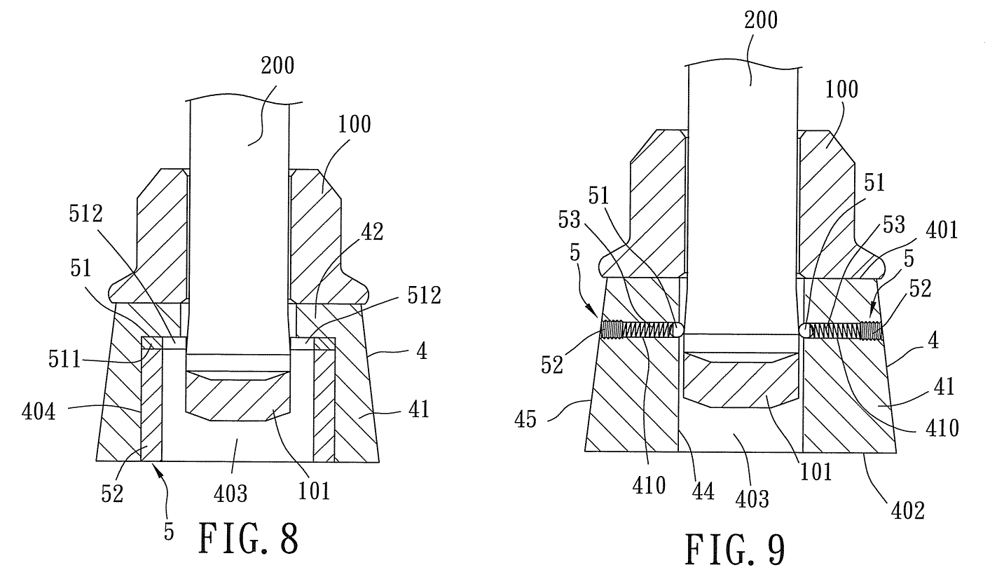

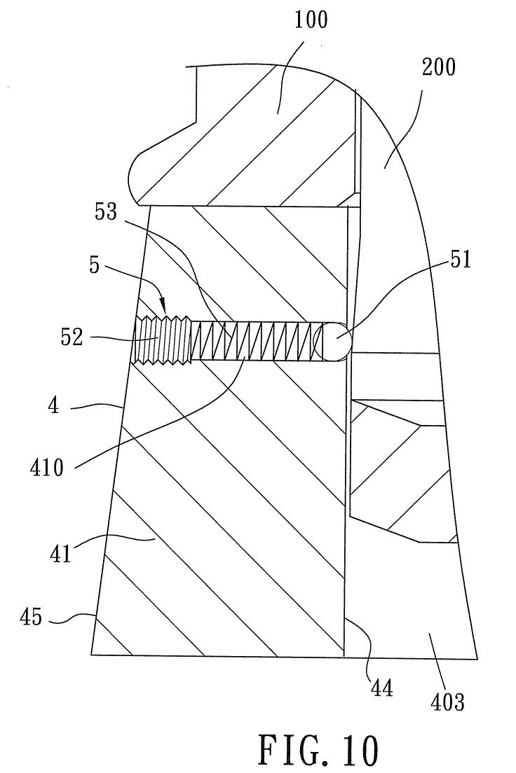

As shown in FIGS. 9 and 10, the fifth embodiment of the die 3 according to the present invention has a structure similar to the first embodiment. The main difference between this embodiment and the first embodiment resides in the following. The die body 4 is not provided with the annular flange portion 42 of the first embodiment. The annular base portion 41 of the die body 4 has an internal surface 44 surrounding the through hole 403, an external surface 45 surrounding the internal surface 404, and a pair of radially opposite mounting holes 410, each of which extends radially through the internal and external surfaces 44, 45. In this embodiment, a pair of limiting units 5 are provided. Each of the limiting units 5 is disposed in a corresponding one of the mounting holes 410, and includes a limit component 51 that protrudes from the internal surface 44 in a direction toward the center of the through hole 403, a positioning component 52 that is proximate to the external surface 45, and a biasing spring 53 that is disposed between the limit component 51 and the positioning component 52 to urge the limit component 51 to protrude from the internal surface 44. In some embodiments, each limit component 51 is formed as a ball. The limit components 51 are movable into the mounting holes 410 against the action of the biasing springs 53 so as to reach the non-limit position when being pushed downward by the punch 200. When the limit components 51 protrude, the distance between the limit components 51 is smaller than the widths of the scrap 101 and the punch 200. The fifth embodiment has the same advantages as those of the first embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A die for cooperating with a punch to pierce a blank, comprising:
a hollow die body having a top surface adapted to support the blank, a bottom surface, and a through hole extending through said top and bottom surfaces, said through hole being adapted to permit a scrap from the blank to move therethrough; and
at least one limiting unit having a limit component which is disposed in said die body below said top surfaces, said limit component being resiliently movable between a non-limit position where the scrap is permitted to pass through said limit component when being pushed downward by the punch, and a limit position, where the scrap is limited from moving upward when the punch is pulled upward.

2. The die as claimed in claim 1, wherein said die body includes an annular base portion having said top and bottom surfaces, and an annular flange portion protruding radially and inwardly from said base portion near said top surface.

3. The die as claimed in claim 2, wherein said limit component has an annular stationary portion disposed fittingly within said through hole below said annular flange portion of said die body, and a plurality of angularly spaced apart resilient plates, said resilient plates projecting axially and upwardly from said annular stationary portion to a bottom end of said annular flange portion, said resilient plates being bendable in directions away from the center of said through hole so as to expand to the non-limit position.

4. The die claimed in claim 3, wherein:
said annular base portion of said die body further has an abutment section proximate to said bottom surface to abut against and retain said annular stationary portion of said limit component, a resilient plate-receiving section formed between said abutment section and said annular flange portion of said die body, and an annular internal surface converging downwardly from a bottom end of said annular flange portion to said bottom surface; and
each of said resilient plates of said limit component has a resilient arm section projecting upwardly and bendably from said annular stationary portion, and a flanged end protruding radially and inwardly from a top end of said resilient arm section opposite to said annular stationary portion, said flanged ends of said resilient plates being adapted to prevent the scrap from moving upward when the punch is pulled upward.

5. The die as claimed in claim 4, wherein said resilient arm sections of said resilient plates of said limit component have a thickness which is smaller than that of said annular stationary portion of said limit component so that said resilient plates have outer surfaces which are indented relative to an outer surface of said annular stationary portion.

6. The die as claimed in claim 3, wherein:
said annular base portion of said die body has an abutment section proximate to said bottom surface, a resilient plate-receiving section formed between said annular flange portion of said die body and said abutment section, and an annular internal surface that converges upwardly from said bottom surface in said abutment section and that has a constant cross-section in said resilient plate-receiving section;
said annular stationary portion of said limit component abuts against said abutment section and converges upwardly from said bottom surface; and
said resilient plates of said limit component extend upwardly and convergingly from said annular stationary portion into said resilient plate-receiving section.

7. The die as claimed in claim 2, wherein said limit component of said limiting unit has an annular stationary portion fixed within said through hole in said annular base portion of said die body below said annular flange portion, and a plurality of radially and inwardly projecting resilient plates that are spaced apart annularly, said resilient plates being resiliently bendable downward to move away from the center of said through hole.

8. The die as claimed in claim 7, wherein said limiting unit further has an annular positioning component fixed within said through hole in said base portion of said die body below said annular stationary portion, said annular stationary portion of said limit component being clamped by said annular positioning component and said annular flange portion.

9. The die as claimed in claim 1, wherein:
a pair of said limiting units are provided;
said die body has an annular base portion having said top and bottom surfaces, an internal surface surrounding said through hole, an external surface surrounding said internal surface, and a pair of radially opposite mounting holes, each of which extends radially through said internal and external surfaces; and
each of said limiting units is disposed in a corresponding one of said mounting holes, and includes a limit component protruding from said internal surface in a direction toward the center of said through hole, a positioning component proximate to said external surface, and a biasing spring disposed between said limit component and said positioning component to urge said limit component to protrude, said limit components being movable into said mounting holes so as to reach the non-limit position.

10. The die as claimed in claim 9, wherein said limit component of each of said limiting units is formed as a ball.
